(19) United States
(12) Patent Application Publication
(10) Pub. No.: US 2008/0180399 A1
(43) Pub. Date: Jul. 31, 2008

(54) Flexible Multi-touch Screen

(76) Inventor: Tung Wan Cheng, Hong Kong (HK)

Correspondence Address: TUNG WAN, CHENG, 100 TAIPEI GENERAL POST OFFICE MAILBOX NO. 1713, TAIPEI, omitted

(21) Appl. No.: 11/669,170

(22) Filed: Jan. 31, 2007

(51) Int. Cl. G06F 3/041

(52) U.S. Cl. 345/173

(57) ABSTRACT

A method, apparatus, and system of flexible multi-touch touch are provided. The invention comprising: a flexible layer; and one or more sensors configured to detect a plurality of simultaneous touching positions at distinct locations of the layer and to generate distinct signals representative of the locations for each of the touches. And a method for flexible touch panel comprising: driving one or more sensors; and detecting a plurality of simultaneous touching positions at distinct locations of a touch panel, wherein the touch panel comprising a flexible property. The invention is also directed towards a flexible multi-touch screen device, comprising: a display as user interface; and a multi-touch panel with flexible property to combine with the display configured to detect a plurality of simultaneous touching positions at distinct locations of the multi-touch panel.

### FIELD OF THE INVENTION

This invention relates generally to a touch screen and, particularly but not exclusively, to an flexible multi-touch screen.

### BACKGROUND OF THE INVENTION

Today, electronic devices provide an increasing amount of functionality with a decreasing size and weight. By continually integrating more and more functions within electronic devices, cost is reduced and reliability is therefore increased. Touch screens are frequently used in combination with conventional displays such as cathode ray tubes (CRTs), liquid crystal display (LCD), plasma displays and electroluminescent displays to provide a easier control. The touch screens are manufactured as devices that can only detect one touching position.

Today, there many styles of input devices for performing operations in a computer system. The operations generally correspond to the moving of a cursor and/or the selection-making on a display screen. For example, the input devices may include buttons or keys, mouse, trackballs, touch pads, joy sticks, touch screens, etc. Touch screens, in particular, are more and more popular because of their ease and versatility of operation as well as of their declining price. Touch screens allow a user to make selections and move a cursor by simply touching the display screen via a finger or stylus. In general, the touch screen recognizes one touch and position of the touch on the display screen, then the computer system interprets the touch and thereafter performs an action based on the touch event.

There are several types of touch screen technologies including resistive, capacitive, infrared, surface acoustic wave, electromagnetic, near field imaging, etc. Each of these devices has advantages and disadvantages that are taken into account when designing or configuring a touch screen. In resistive technologies, the resistive touch screen panel is coated with a thin metallic electrically conductive and resistive layer that causes a change in the electrical current which is registered as a touch event and is sent to the controller for processing. In capacitive technologies, the capacitive touch screen panel is coated with a material, typically indium tin oxide, that conducts a continuous electrical current across the sensor. The sensor therefore exhibits a precisely controlled field of stored electrons in both the horizontal and vertical axes—it achieves capacitance. The human body is also an electrical device which has stored electrons and therefore also exhibits capacitance. When the sensor's ‘normal’ capacitance field (its reference state) is altered by another capacitance field, for example, someone's finger, electronic circuits located at each corner of the panel measure the resultant ‘distortion’ in the sine wave characteristics of the reference field and send the information about the event to the controller for mathematical processing. Capacitive sensors can either be touched with a bare finger or with a conductive device being held by a bare hand. Capacitive touch screens are not affected by outside elements and have high clarity.

In surface acoustic wave technologies, ultrasonic waves that pass over the touch screen panel. When the panel is touched, a portion of the wave is absorbed. This change in the ultrasonic waves registers the position of the touch event and sends this information to the controller for processing. Surface wave touch screen panels can be damaged by outside elements. Contaminants on the surface can also interfere with the functionality of the touch screen. In infrared technologies, the infrared touch screen panel employs one of two very different methodologies. One method uses thermal that induces changes of the surface resistance. This method was sometimes slow and required warm hands. Another method is an array of vertical and horizontal IR sensors that detects the interruption of a modulated light beam near the surface of the screen. IR touch screens have the most durable surfaces and are used in many military applications that require a touch panel display.

In strain gauge technology, the screen is spring mounted on the four corners and strain gauges are used to determine deflection when the screen is touched. This technology can also measure the Z-axis. Typical application includes protecting new touch-screen railway ticket machines from vandalism.

In dispersive signal technology, which introduced in 2002, the touch panel uses sensors to detect the mechanical energy in the glass that occur due to a touch. Complex algorithms then interpret this information and provide the actual location of the touch. The technology claims to be unaffected by dust and other outside elements, including scratches. Since there is no need for additional elements on screen, it also claims to provide excellent optical clarity. Also, since mechanical vibrations are used to detect a touch event, any object can be used to generate these events, including fingers and styli.

In acoustic pulse recognition, the panel uses four piezoelectric transducers located at each side of the screen to turn the mechanical energy of a touch into an electronic signal. This signal is then converted into an audio file, and is then compared to preexisting audio profile for every position on the screen. This system works without a grid of wires running through the screen; the touch screen itself is actually pure glass, giving it the optics and durability of the glass out of which it is made. It works with scratches and dust on the screen, and accuracy is very good. It does not need a conductive object to activate it.

Some of these technologies, such as capacitive, are capable of reporting multiple points when multiple objects are touched on the sensing surface. The multi-touch screen is the trend of touch screen. But the solid, rigid substrates or material used on these devices diminish their suitability for mobile computerized systems, such as laptop computers, handheld computers, cellular telephones, etc. The weight of such sensors and their capacity for breaking are also important factors militating against their use in such systems. Mobile devices also experience far more mechanical flexing than stationary devices. A rigid, brittle and heavy component incorporated into such a device is incompatible with light and flexible components, and it may cause such flexible components to fail. Similar considerations apply to displays mounted in vehicles and large displays mounted on walls. Brittle, rigid substrates or material also increase the thickness of a display in products for which a low profile provides a commercial advantage.

Touch sensors based on glass substrates also require a specially fitted frame for mounting the sensor over a monitor or display. Such frames further add to the weight, cost and complexity of the device. A flat and solid substrate also does not conform well to displays or monitors with uneven or curved surfaces either Furthermore, bending rigid substrates requires expensive processing. Glass based touch sensors, moreover, must be manufactured from individual substrates of cut glass. Such manufacture is costly and time-consuming. All of these deficiencies diminish the desirability of existing flexible touch sensors in some applications.

### BRIEF DESCRIPTION OF THE DRAWINGS

FIG. 1 is a schematic diagram showing a multi-touch screen and flexible display according to one embodiment of the present invention;

FIG. 2 is an illustration of the multi-touch screen together with a plurality of component according to the present invention;

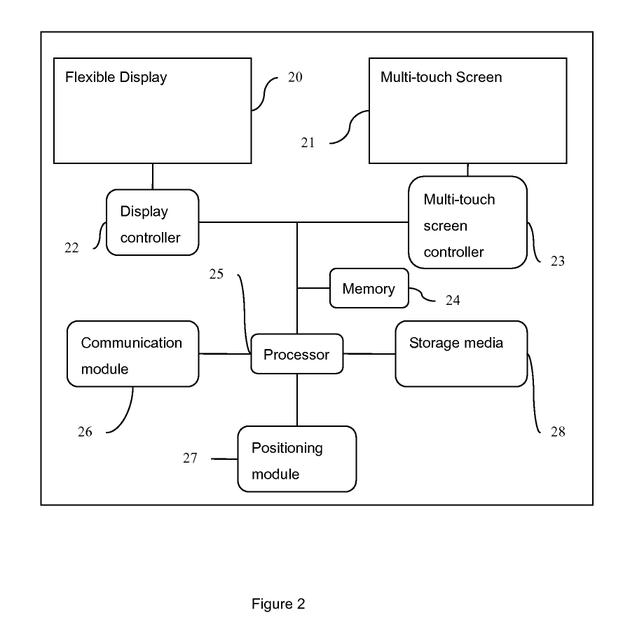

FIG. 3 is an illustration of a top view of a transparent flexible multi-touch screen, according to one embodiment of the present invention;

FIG. 4 is an illustration of a top view of a transparent flexible multi-touch screen, according to one embodiment of the present invention;

FIG. 5 is an illustration of flexible multi-touch screen device, according to one embodiment of the present invention;

### SUMMARY OF THE INVENTION

The invention is directed towards a touch panel with a flexible property comprising: a) A flexible layer; and b) One or more sensors configured to detect a plurality of simultaneous touching positions at distinct locations of the layer and to generate distinct signals representative of the locations for each of the touches. And a method for flexible touch panel comprising: a) Driving one or more sensors; and b) Detecting a plurality of simultaneous touching positions at distinct locations of a touch panel, wherein the touch panel comprising a flexible property.

The invention is also directed towards a flexible multi-touch screen device, comprising: a) A display as user interface; and b) A multi-touch panel with flexible property to combine with the display configured to detect a plurality of simultaneous touching positions at distinct locations of the multi-touch panel.

The present invention has the notable improvement of a thin, light, easily-manufactured device with a multi-touch screen comprising reduced weight, size, and cost. A more reliable, inexpensive, lightweight, flexible, transparent, durable, and easy-controlling touch sensor and an efficient, low-cost method of manufacturing are disclosed that can increase the malleability, endure attack, allow multi-touch and ensure improved sensitivity and resolution.

### DETAILED DESCRIPTION OF THE INVENTION

The present invention is generally applicable to flexible touching systems and particularly to flexible touching panels where a plurality of touches may be applied by one or more users. The present invention is particularly suited to a touch system where some portion of a plurality of touch inputs may occur simultaneously or otherwise temporally overlap. One embodiment of the present invention may be suited for use in a electronic map designed to be used by one or more users at the same time where, in the course of using the map, users can apply touch input to generate a response in the map, and where a plurality of touches may start at the same time and/or end at the same time and/or overlap for at least part of the time during which each touch is applied. Such touch inputs can be referred to as overlapping touches, double touches, or simultaneous touches. After the use of the map, it can roll up to reduce the size.

In a touch screen panel, the position of a touch applied by a user is generally determined by measuring distinct signals generated by each touch input, and then comparing the signals or ratios of the signals to calculate the position of each touch. The location data can then be correlated to a particular action or instruction, for example. Measured signals include electrical current, electrical voltage, electromagnetic energy, light energy, wave energy, bending movement, acceleration, force per unit area, and the like. Assuming a properly calibrated touch panel, the calculated position of a touch should be sufficiently close to the actual location touched by the user so that the user's intended instruction can be carried out. The distance between the actual touch location and the corresponding reported touch location that is said to be sufficiently close is determined, in part, by the resolution of the touch system. A reported touch location that sufficiently closely corresponds to an actual location touched by a user is referred to as a valid touch.

Generally, a touch applied to a touch screen includes three steps, namely touch-down, hold, and lift-off. The signals that are measured to calculate the location of a touch is determined against a background level, which is the residual signal level presented when no touch is being applied. When a touch is applied the signal increases from its background value to a new value, referred to as the hold value, which is measurably different from the background level. The transition from background to a hold level is called touch-down. The applied touch is generally held for a finite time which is referred to as the hold time, corresponding to the hold step, during which the hold signal ideally remains relatively constant, or more practically, fluctuates within a range where all values are substantially larger than the background level. The hold time is generally long enough that a touch location may be measured. At the end of the hold time and as the user removes the applied touch, the value of the generated signal decreases from its hold value to a background level. This is referred to as lift-off.

Using a touch panel may limit or prohibit the use of the touch screen panel in certain applications, such as those applications where two or more simultaneous or overlapping touches may foreseeably, or even desirably, be applied by one or more users. For example, it may be desirable to employ touch screens in electronic map used by a plurality of users who use a single touch screen to input instructions at the same times. Even though each player may use a separate and pre-determined section of the touch screen when using the map, in the course of using, many overlapping touch events may occur as each user touches his section of the touch screen.

The present invention provides flexible multi-touch panel which is configured to detect a plurality of simultaneous touching positions at distinct locations of it. A touch panel may utilize detecting techniques such as dispersive signal technology, resistive technology, capacitive technology, electromagnetic induction technology, surface wave technology, acoustic pulse recognition, strain gauge, optical technology or other technology suitable for touch panel.

One embodiment of the device includes a flexible touch screen that is operatively coupled to the controller. The flexible touch screen is a transparent panel that is positioned in front of the flexible display device, in the rear of the flexible display device, adjacent to the flexible display device or within of the flexible display device. The flexible touch screen may be integrated with the flexible display device or it may be a separate component. The flexible touch screen may have the same substrate with the display or it may have its own. The flexible touch screen is configured to receive input from a user's touch and to send this information to the controller. In most cases, the flexible touch screen recognizes touches, the positions, and the magnitude of touches on its surface. The flexible touch screen reports the touches to the controller and then the controller interprets the touches in accordance with its programming.

In accordance with one embodiment, the flexible touch screen is capable of tracking multiple objects, which rest on, tap on, or move across the touch sensitive surface of the flexible touch screen at the same time. The multiple objects may for example correspond to fingers, palms, pen or any tool. Because the flexible touch screen is capable of tracking multiple objects, a user may perform several touch initiated tasks at the same time. For example, the user may select an item from a menu with one finger, while moving a cursor with another finger. In addition, a user may select an onscreen button with one finger while moving a scroll bar with another finger. Furthermore, the first object may be dragged with one finger while the second object may be dragged with another finger. Moreover, gesturing may be performed with more than one finger.

To elaborate, the flexible touch screen generally includes a sensing device configured to detect an object in close proximity thereto and/or the pressure exerted thereon. The sensor may be widely varied. In one particular embodiment, the sensor is divided into several independent and spatially distinct sensing points, nodes or regions that are positioned throughout the flexible touch screen. The sensors, which are typically hidden from view, are dispersed about the flexible touch screen with each sensor representing a different place within the flexible touch screen. The sensor may be placed in a grid or a pixel array where each pixilated sensor is capable of generating a signal at the same time. In the simplest case, a signal is produced each time when an object is positioned over a sensor. When an object is placed over multiple sensors or when the object is moved between or over multiple sensors, multiple signals are generated. For flexible property, the sensor may be make up of flexible materials.

The arrangement of the sensor may be widely varied. The quantity of sensor generally depends on the desired sensitivity, desired flexibility and the desired transparency of the touch screen. More sensors generally increase sensitivity, flexibility, but reduce transparency (vice versa) at the same time. With regards to arrangement, the sensors generally map the touch screen into a coordinate system such as a Cartesian coordinate system, a Polar coordinate system or some other coordinate systems. When a Cartesian coordinate system is used (as shown), the sensor typically correspond to x and y coordinates. When a Polar coordinate system is used, the sensing points typically correspond to radial (r) and angular coordinates ([theta]).

The flexible touch screen may include a sensing controller that acquires the data from the sensing device and that supplies the acquired data to the processor. Alternatively, the processor may include this functionality. In one embodiment, the sensing controller is configured to send raw signal data to the processor so that the processor processes the raw data. For example, the processor receives signal data from the sensing controller and then determines how those data to be used within the electronic device. The data may include the coordinates of each sensor and the pressure exerted on each sensor. In another embodiment, the sensor is configured to process the raw data itself. The sensing controller receive the pulses from the sensor and turns them into data understood by the processor. The sensing controller may perform filtering and/or conversion processes. Filtering processes are typically implemented to reduce congestion of data stream so that the processor will not overload with redundant or non-essential data. The conversion processes may be implemented to adjust the raw data before sending or reporting them to the processor 56. The conversions may include determining the center point for each touch region (e.g., centroid).

The sensing controller may include a memory element for storing a touch screen program, which may control different aspects of the flexible touch screen. For example, the touch screen program may contain the type of value to output based on the sensor selected (e.g., coordinates). In fact, the sensing controller in connection with the touch screen program may use a predetermined communication protocol. As is generally, the communication protocols are a set of rules and procedures for exchanging data between two devices. Communication protocols typically transmit information in data blocks or packets that contain the data to be transmitted, the data required to direct the packet to its destination, and the data that corrects errors that occur along the way.

The sensing controller is generally composed by one or more microcontrollers, each of which monitors one or more sensors. The microcontrollers may, for example correspond to an integrated circuit (IC), which works with firmware to monitor the signals from the sensing device and to process the monitored signals and report to the processor.

In accordance with one embodiment, the sensing device is based on capacitance. As should be appreciated, whenever two electrically conductive members come close to each other without actually touching, their electric fields interact to form capacitance. In cases, the first electrically conductive member is a sensor and another electrically conductive member is an object such as a finger. As the object approaches the surface of the touch screen, a tiny capacitance forms between the object and the sensor in close proximity to the object. By detecting changes in capacitance at each of the sensor and noting the position of the sensor, the sensing controller can recognize multiple objects and determine the location, pressure, direction, speed and acceleration of the objects as they are moved across the touch screen. For example, the sensing controller can determine when and where each of the fingers and palm of one or more hands are touching as well as the pressure being exerted by the finger and palm of the hand(s) at the same time.

The simplicity of capacitance allows for a great deal of flexibility in design and construction of the sensing device. For example, the sensing device may be based on self capacitance or mutual capacitance. In self capacitance, each of the sensors is provided by an individual charged electrode. When an object approaches the surface of the touch screen, the object capacitively couples to those electrodes in close proximity to the object thereby attract charge away from the electrodes. The amount of charge in each of the electrodes is measured by the sensing controller to determine the positions of different touching objects. In mutual capacitance, the sensing device includes a two layer grid of spatially separated lines or wires. For the simplest case, the upper layer includes lines in rows while the lower layer includes lines in columns (e.g., orthogonal). The intersections of the upper layer and lower layer lines become sensors. During operation, the rows are charged and the charge capacitively couples to the columns at the intersection. As an object approaches the surface of the touch screen, the object capacitively couples to the rows at the intersections in close proximity to the object thereby attract charge away from the rows and therefore the columns as well. The amount of charge in each of the columns is measured by the sensing controller to determine the positions of different touching objects.

In accordance with another embodiment, the sensing device is based on resistance. As should be appreciated, resistive touch screen composed of a flexible top layer and a flexible bottom layer, which forms separately by insulate material, such as insulating dots, attached to a sensing controller. The inside surface of each of the two layers is coated with a transparent metal oxide coating (ITO) or conductive ink as the sensor that facilitates a gradient across each layer when voltage is applied. Pressing the flexible top sheet creates electrical contact between the resistive layers, producing a switch closing in the circuit. The control electronics alternate voltage between the layers and pass the resulting X and Y touch coordinates to the sensing controller. The sensing controller data is then passed on to the computer operating system for processing. The sensing controller can recognize multiple objects, and determine the location, pressure, direction, speed and acceleration of the objects as they are moved across the touch screen. For example, the sensing controller can determine when and where each of the fingers and palm of one or more hands are touching as well as the pressure being exerted by the finger and palm of the hand(s) at the same time.

The simplicity of resistance allows for a great deal of flexibility in design and construction of the sensing device. For example, the sensing device may be based on self resistance or mutual resistance. In self resistance, each of the sensors is provided by an individual metal oxide coating on bottom layer. When an object presses the surface of the touch screen, the upper layer couples to those individual metal oxide coating on bottom layer which will produce a switch closing in the circuit. The amount of alternate voltage between the layers is measured by the sensing controller to determine the positions of different touching objects. In mutual resistance, the sensing device includes a two layer grid of spatially separated metal oxide lines or wires. For the simplest case, the upper layer includes lines in rows while the lower layer includes lines in columns (e.g., orthogonal). The intersections of the upper layer and lower layer lines become sensors. During operation, the rows are charged. As an object presses the surface of the touch screen, the object presses the rows at the intersections with the columns, and therefore switch closing in the circuit. The amount of closing in the circuit in each of the columns and rows is measured by the sensing controller to determine the positions of different touching objects.

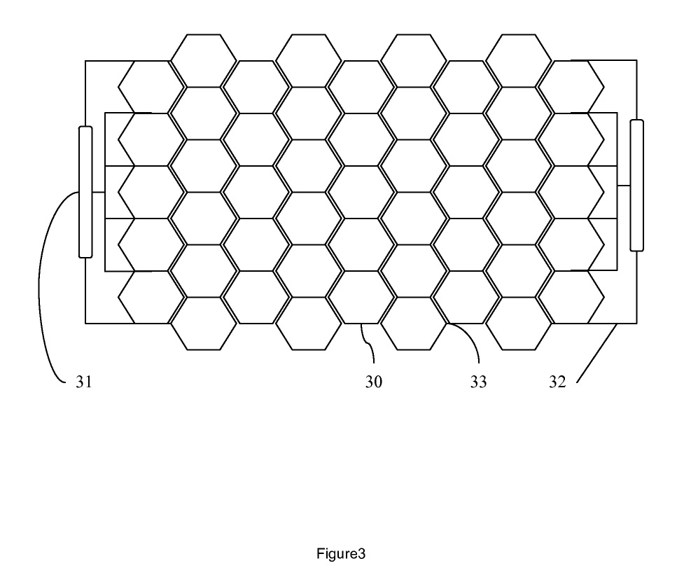

According to FIG. 3, the flexible multipoint touch screen is capable of sensing the position and the pressure of multiple objects at the same time. This particular touch screen is based on a plurality of transparent sensors 30, and each represents different coordinate of the touch screen. The sensors are configured to detect input from one or more objects touching the screen in the vicinity of the sensors. The sensors are connected to a sensing controller through a plurality of thin, flexible, electrical leads that are positioned in the gaps 33 between the spaced apart sensors or in the different level of sensors. The sensors are spaced apart in order to electrically isolate them from each other. The gap is preferably made small enough to maximize the sensing area and to minimize optical differences between the space and the transparent sensors.

The thin, flexible, electrical sense lead 32 is electrical contact with the sensors for transmitting electrical signals to and from the sensors where they also connected to the sensing controller. The sensing controller 31 includes one or more sensor ICs that measure the signal form each sensor and report their findings or some forms thereof to a host controller. The sensor ICs may for example convert the analog signals to digital data and thereafter transmit the digital data over a serial bus to a host controller. Any number of sensor ICs may be used. For example, a single chip may be used for all sensors, or multiple chips may be used for a single or group of sensors.

The sensors, leads and sensing controller are generally disposed on an optical transmissive member. In most cases, the optically transmissive member is formed from a clear flexible material such as thin glass or flexible plastic. The member preferably is a sheet of polyethylene terephthalate (PET), and this member may be a flexible sheet of another suitable material, e. g., polycarbonate polyester, polyvinyl chloride, polyether sulfone, polyimide polyether imide, cellulose triacetate and polyethelene naphthalate. The sensors, leads and conductive areas preferably comprise indium tin oxide (ITO) or conductive ink, most preferably silver epoxy conductive ink, and this conductive ink preferably is deposited by screen printing or ink-jet printing. In addition, the sensor ICs of the sensing controller can be electrically coupled to the leads using any suitable techniques.

The distribution of the sensors may be widely varied. For example, the sensors may be placed everywhere in the touch screen. The sensors may be placed randomly or in a particular pattern. The position of the sensors may depend on the coordinate system used. Furthermore, the sensors may be formed from almost any shape whether simple (e.g., squares, circles, ovals, triangles, rectangles, polygons, and the like) or complex (e.g., random shapes). Moreover, the sensors may have identical shapes or they may have different shapes. The shapes are generally chosen to maximize the sensing area and to minimize optical differences between the gaps and the transparent sensors.

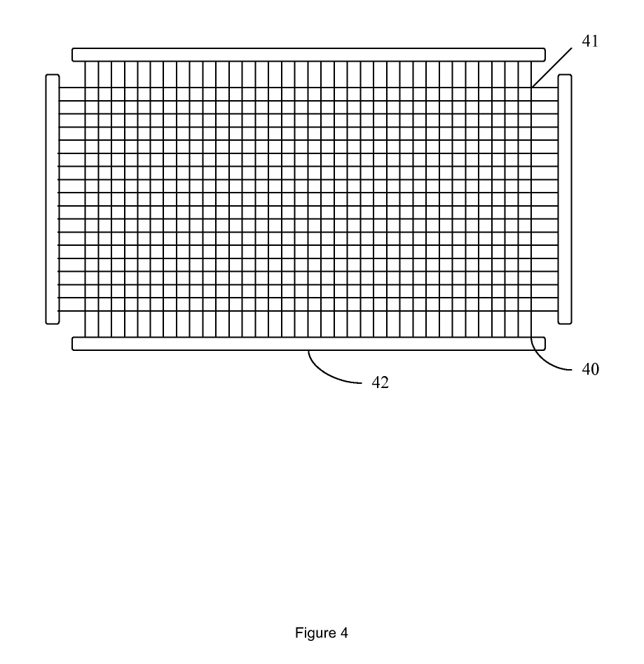

According to FIG. 4, another embodiment of the invention, unlike the touch screen above, the touch screen includes a two layer grid of spatially separated lines or wires. In most cases, the lines 40 on each layer are parallel to one another. Furthermore, the lines on the different layers are configured to intersect or cross in order to produce sensor 41, and each represents different coordinates in the touch screen. They are configured to detect input from one or more objects touching the screen in the vicinity of the sensors. The top layer provides the driving lines while the bottom layer provides the sensing lines (vice verse). The driving lines are connected to a voltage source that separately drives the current through each of the driving lines. That is, the stimulus is only happening over one line while all the other lines are grounded. They may be driven similarly to a raster scan. The sensing lines are connected with sensing controller that continuously senses all of the sensing lines. Each line is make of flexible materials, such as, conductive ink.

When driven, the charge on the driving line to the intersecting sensing lines through the nodes and the sensing controller senses all of the sensing lines in parallel. Thereafter, the next driving line is driven, and the charge on the next driving line intersecting sensing lines through the sensor and the sensing controller senses all of the sensing lines in parallel. This happens sequential until all the lines have been driven. Once all the lines have been driven, the sequence starts over (continuously repeats). In most cases, the lines are sequentially driven from one side to the opposite side.

The sensing controller 42 includes one or more sensor ICs that measure the signal form each lines and report their findings or some form thereof to a host controller. The sensor ICs may for example convert the analog signals to digital data and thereafter transmit the digital data over a serial bus to a host controller. Any number of sensor ICs may be used. For example, a single chip may be used for all lines, or multiple chips may be used for a single or group of lines.

The lines are generally disposed on an optical transmissive member. In most cases, the optically transmissive member is formed from a clear flexible material such as thin glass or flexible plastic. The member preferably is a sheet of polyethylene terephthalate (PET), and this member may be a flexible sheet of another suitable material, e. g., polycarbonate polyester, polyvinyl chloride, polyether sulfone, polyimide polyether imide, cellulose triacetate and polyethelene naphthalate. The lines and conductive areas preferably comprise indium tin oxide (ITO) or conductive ink, most preferably silver epoxy conductive ink, and this conductive ink preferably is deposited by screen printing or ink-jet printing. In addition, the sensor ICs of the sensing controller can be electrically coupled to the leads using any suitable techniques.

The distribution of the lines may be widely varied. For example, the lines may be placed everywhere in the touch screen. The lines may be placed randomly or in a particular pattern. The position of the liners may depend on the coordinate system used. Moreover, any number of lines may be used. It is generally believed that the number of lines depend on the desired resolution of the touch screen. The number of lines within each layer may be identical or different. The number of lines is typically determined by the size of the touch screen as well as the desired pitch and line widths of the lines.

What mentioned above are just primarily example of multi-touch technique used in flexible multi-touch panel, there are still many techniques can be used in flexible multi-touch panel, such as, dispersive signal technology, electromagnetic induction technology, surface wave technology, acoustic pulse recognition, strain gauge, optical technology or other suitable technology. Any touch screen technique or formation which is configured to detect a plurality of simultaneous touching positions and has a flexible property is suitable to implement in the present invention.

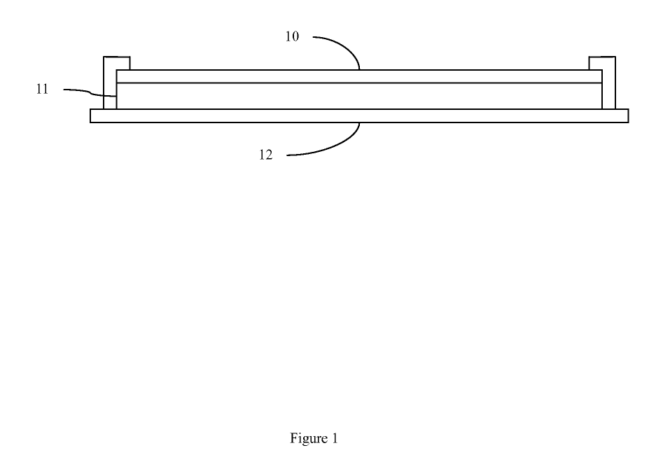

Referring to FIG. 1, a flexible multi-touch screen device is a system of one embodiment of the present invention includes a flexible display 11. In certain embodiments of the present invention, the existence of flexible display which is a display that facilitates folding. Flexible display may be an OLED display, PLED display, active matrix liquid crystal display, passive matrix liquid crystal display, electrophoretic display, cholesteric liquid crystal display, polymer dispersed liquid crystal, nematic liquid crystal display, Gyricon or display with flexible characteristic, which may be transparent or non-transparent, 3D or 2D. Accordingly, flexible may include any suitable substrate 12 such as plastic, thin metal, thin glass, or material that is flexible, Substrate preferably comprises a sheet of polyethylene terephthalate (PET). In lieu of PET, substrate may be a flexible sheet of another suitable material, e. g., polycarbonate polyester, polyvinyl chloride, polyether sulfone, polyimide polyether imide, cellulose triacetate and polyethelene naphthalate.

The image displaying program in display controller is a program for generating image each to be displayed on the flexible display and the flexible display on the basis of image data. According to this program, an image including a user character is displayed on the flexible display, for example. The coordinates detecting program in touch screen controller is a program for detecting coordinates data input from the touch panel in response to an operation of the touch panel by the user. In a case that the user simultaneously points two points on the touch panel, for example, coordinates of the two touching positions are detected by touch screen controller through the coordinate data.

The flexible multi-touch screen device is flexible screen utilizing multi-touch panel 10 and the flexible display is provided with a touch panel cover the surface.

The positional relationship calculating program is a program for calculating, in response to a simultaneous touch operation of the touching points by the user, a positional relationship between the points. Or, this may be a program for calculating a touching state of the two points by the user. That is, according to this program, at least one of a distance between the two points touched by the user and an angle of a line connecting the two points is calculated. Here, the angle of the line connecting the two points is an angle formed by the line connecting the touched two points and a reference line (horizontal line, for example). Furthermore, as to the direction of the angle of the line connecting the two points, the left direction, that is, a counterclockwise direction, for example, is set to a plus direction. It is noted that the angle of the line connecting the two points may be referred to as an angle between the two points. When (X1,Y1) and (X2,Y2) are detected as the coordinates of the two points, the distance L between the two points and an angle [theta] between the two points are calculated by Pythagoras' Theorem. Furthermore, in this embodiment, according to this program, a central point of the touched two points (central coordinate) is also calculated. These distance, angle and central coordinates value, etc. between the two points are calculated every time a unit of time elapses, such as each frame or every predetermined number of frames.

The movement detecting program is a program for detecting traveling of the touching. The movement calculation is a calculation set for controlling a traveling of the user character and the traveling of the user character is determined on the basis of this movement calculation. The movement calculation includes a plurality of elements relating to movements. In this embodiment, a travel speed, a turning angle, acceleration, direction, etc are prepared as the movement calculation. For example, the movement calculation is set on the basis of at least one of the distance between the two points and the angle of the line connecting the two points. Specifically, out of the movement calculation of the user character, the travel speed is set on the basis of the distance between the two points and the turning angle is set on the basis of the angle of the line connecting the two points. Furthermore, in this embodiment, a display position of the user character as the movement calculation of the user character is set on the basis of the central coordinate between the two points.

On the basis of the movement calculation set calculated by the movement detecting program, the character movement controlling program to be described later controls the movement of the user character. Accordingly, the user can control the travel speed, direction, travel acceleration or the turning angle of the user character in correspondence with a distance or angle between the two points touched by his two fingers, etc.

Furthermore, the movement detecting program, when the distance and angle between the two touching points calculated by the positional relationship calculating program changes, changes the movement calculation on the basis of these change amounts. Specifically, the travel speed of the user character is changed on the basis of the change amount of the distance between the two points; the travel acceleration of the user character is changed on the basis of the change amount of the speed. For example, on the basis of the change amount of the distance, acceleration or deceleration of the travel speed is set. In a case the distance is changed to be increased, the acceleration of the travel speed is set and in a case that distance is changed to be reduced, the deceleration of the travel speed is set. Furthermore, the turning angle of the user character is changed on the basis of the change amount of the angle between the two points. In addition, the display position of the user character is set on the basis of the central point currently calculated.

The movement controlling program described later controls the movement of the user character on the basis of the movement calculation changed by the movement detecting program. Accordingly, the user can change the travel speed or turning angle of the user character by changing the distance or angle between the two points.

The movement controlling program is a program for controlling the movement of the user character. The movement of the user character is controlled on the basis of the movement calculation. More specifically, the travel of the user character is controlled on the basis of the travel speed of the movement calculation detect by the movement detecting program. Furthermore, the turn, rotation, or change of direction of the user character is controlled on the basis of the turning angle of the set movement calculation. In addition, the display position of the user character is controlled on the basis of the display position of the set movement calculation.

Furthermore, touching area detecting program is a program for calculating, in response to a simultaneous touch operation of the touching points by the user, a touching area of the points. That is, according to this program, at least one of an area touching by the user is calculated. Here, the area of the touching points is an area formed by the touching points joins together. Furthermore, to detect the touching points that are joining together, it is easy to calculate the shape and size of the touching area.

While the above program and controller has been described primarily in detecting and calculating the touching position signal, any form of detecting and calculating which provide similar functionality is suitable to implement the invention.

One embodiment of the flexible multi-touch screen device is available to comprise a processor configured to execute instructions and to carry out operations associated with the device. For example, using instructions retrieved for example from memory, the processor may control the reception and manipulation of input and output data between components of the device. The processor can be a single-chip processor or can be implemented with multiple components.

One embodiment of the flexible multi-touch screen device is available to communicate with others. In a conventional implementation, the communications module will enable a communications network supporting conventional software and protocol stacks as well as the hardware supporting for wired or wireless operation within the system or detachable with the system. These communication technologies may be, Ethernet, PSTN, ISDN, ADSL, TCP/IP protocols, 802.11b, 802.11n, 2G (GSM, GPRS, CDMA, etc), 3G (WCDMA, CDMA2000, etc), 4G (OFDM, etc), 5G, WiFi, WiMax, WLAN, WiBro, MobileFi (IEEE 802.20), infrared rays, Ultra Wideband, ultrasound, microwave, Very small aperture terminals, Advanced Communication Technology Satellite, Digital Video Broadcasting (BVD-S, BVD-S2, BVD-C, BVD-T, BVD-H), MediaFLO, Bluetooth wireless standards or any other communication network. Including communications module, the system may be a mobile phone, PDA, hand-held electronic device, menu, television, monitor, remote control, keyboard, questionnaire, notebook computer or other devices needed in communication with others.

One embodiment of the flexible multi-touch screen device is available to store data. In a conventional implementation, the storage media or memory will enable a data storage supporting conventional software as well as the hardware supporting for storage within the system or detachable with the system. These storage media may be hard disk, tape, diskette media, CD, DVD, Flash memory, RAM memory or any other storage media or memory. Including storage media, the system may be a movie player, computer, music player, electronic book, electronic paper, electronic art paper, electronic picture, electronic drawing, object of art, window, windscreen, business card, tag, controller, game player, camera, calculator, video camera, advertisement display, electronic notice board, sale machine, service machines, watch, clock, clothes, glasses, keyboard, label, board for teaching, database device or other device needed in storage media or memory.

One embodiment of the flexible multi-touch screen device is available to positioning. In a conventional implementation, the positioning module will enable positioning supporting conventional software as well as the hardware supporting for positioning within the system or detachable with the system. These positioning modules may be GPS, A-GPS, E-OTD, TDOA, AFLT or any other positioning technique. Including positioning module, the system may be an electronic map, GPS device, electronic position device or other device need positioning. If use transparent display, it may be part of windscreen.

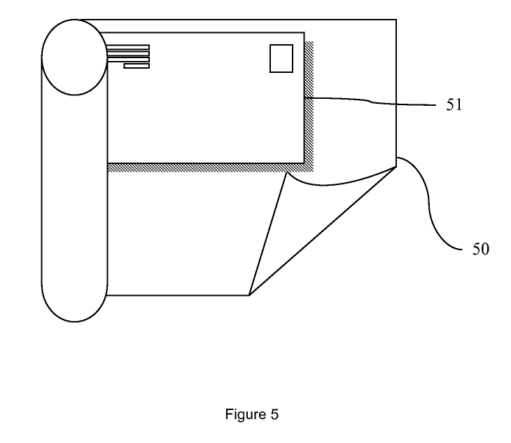

FIG. 5 is one embodiment of device which comprises a flexible multi-touch device 50 and an image 51 display on it. It may roll up if it is not in use.

While the above invention has been described primarily in relation to flexible multi-touch screen device, the entire components may have flexible property, any form of system which provides similar functionality is suitable to implement the invention.

1. A touch panel, with a flexible property, comprises:
a) A flexible panel layer; and
b) One or more sensors configured to have capability of detecting a plurality of simultaneous touching positions at distinct locations of the layer and to generate corresponding signal(s) representing the location for each of the touches.

2. A touch panel according to claim 1, wherein further comprises a multi-touch screen controller for recognizing coordinates of the plural touching positions.

3. A touch panel according to claim 1, wherein further comprises a display as an output interface.

4. A touch panel according to claim 1, wherein further comprises the sensor(s) configured to detect a singular touching position at distinct location of the flexible touch panel.

5. A touch panel according to claim 1, wherein the sensor comprises a flexible property.

6. A touch panel according to claim 1, wherein the layer comprises:
a plurality of flexible and isolated sensors and flexible conductive leads; each of said sensors is placed at different place within the flexible touch panel, and has its own lead coupling to monitor.

7. A touch panel according to claim 1, wherein the layer comprises:
a plurality of flexible and isolated conductive lines; and further comprises a second flexible layer spatially separated from the first layer and a plurality of flexible isolated conductive lines that are formed transverse to the conductive lines of first layer; the intersection of transverse lines are set at different places within the touch panel as the sensors and each of the conductive lines is coupled to monitoring controller.

8. A method for flexible touch panel comprises:
a) Driving one or more sensors; and
b) Detecting a plurality of simultaneous touching positions at distinct locations of a touch panel, wherein the touch panel has a flexible property.

9. A method according to claim 8, wherein further comprises the recognition of the plural touching area.

10. A method according to claim 8, wherein further comprises the recognition of the touching travel speed or the touching travel acceleration/deceleration.

11. A method according to claim 8, wherein further comprises the recognition of the touching travel direction or the change of touching travel direction.

12. A method according to claim 8, wherein further comprises the detection of a singular touching position at distinct location of the flexible touch panel.

13. A flexible multi-touch screen device comprises:
a) A display as user interface; and
b) A multi-touch panel with flexible property to combine with the display configured to have capability of detecting a plurality of simultaneous touching positions at distinct locations of the multi-touch panel.

14. A flexible multi-touch screen device according to claim 13, wherein the touch panel may be positioned in front of, in the rear of, adjacent to or within of the display.

15. A flexible multi-touch screen device according to claim 13, wherein further comprises a communication module for communication.

16. A flexible multi-touch screen device according to claim 13, wherein the display comprises a flexible property.

17. A flexible multi-touch screen device according to claim 13, wherein further comprises a display controller for controlling the display.

18. A flexible multi-touch screen device according to claim 13, wherein the display comprises a 3D display functionality.

19. A flexible multi-touch screen device according to claim 13, wherein further comprises a processor for calculation.

20. A flexible multi-touch screen device according to claim 13, wherein further comprises a memory for data storage.

21. A flexible multi-touch screen device according to claim 13, wherein further comprises a storage media for data storage.

22. A flexible multi-touch screen device according to claim 13, wherein further comprises a substrate with a flexible property.

23. A flexible multi-touch screen device according to claim 13, wherein further comprises a positioning module for detecting position of the device.
